(19) United States
(12) Patent Application Publication
(10) Pub. No.: US 2026/0255280 A1
(43) Pub. Date: Aug. 27, 2026

(54) METHOD FOR SRS CONFIGURED MAXIMUM POWER

(71) Applicant: Telefonaktiebolaget LM Ericsson (publ), Stockholm (SE)

(72) Inventors: Maomao CHEN LARSSON, Lund (SE); Christian BERGLJUNG, Lund (SE); Robert Mark HARRISON, Grapevine, TX (US); Stefan CEROVIC, Paris (FR)

(21) Appl. No.: 19/160,309

(22) PCT Filed: Feb. 27, 2024
(86) PCT No.: PCT/EP2024/054911

§ 371 Date: Aug. 27, 2025

Related U.S. Application Data
(60) Provisional application No. 63/487,432, filed on Feb. 28, 2023.

(51) Int. Cl. H04W 52/36; H04L 27/26

(52) U.S. Cl. CPC H04W 52/365; H04L 27/261

(57) ABSTRACT

A method, system and apparatus are disclosed. A method implemented in a wireless device is provided. The method includes receiving, from a network node, a Sounding Reference Signal, SRS, configuration indication including SRS resource set information, determining a power headroom report, PHR, set for at least one activated serving cell, where the PHR includes PH information associated with at least one SRS resource included in the SRS resource set, and transmitting, to the network node, the PHR including the PH information for the at least one SRS resource.

### FIELD

The present disclosure relates to wireless communications, and in particular, to supporting configurations for sounding reference signal (SRS) configured maximum power.

### INTRODUCTION

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### General Information on SRS

In some wireless communication systems, e.g., some 5G NR networks, a WD (e.g., user equipment (UE)) typically receives numerous and/or frequent requests to either increase or decrease the WD transmit power, which may be defined, e.g., by uplink power control procedures by determining the transmit power of the different uplink physical channels (PUCCH, PUSCH) or signals (SRS, PRACH). The SRS, i.e., Sounding Reference Signal, may be used for uplink channel sounding and beam management. SRS may be configured for periodic, semi-persistent and aperiodic transmission on one or multiple antenna ports. Various example uses for SRS transmission include the following (‘usage’ in the configuration of SRS):
‘beamManagement’: beam management (for NR FR2) to identify the best WD transmit beam and best base station receive beam;
‘codebook’: codebook-based PUSCH transmission, used for UL SU-MIMO;
‘nonCodebook’: reciprocity based PUSCH transmission with precoded SRS;
‘antennaSwitching’: DL CSI acquisition for reciprocity-based DL MIMO, each WD antenna port is sounded in the UL (connector or Tx chain in the WD)

Uplink measurements from a network node (e.g., gNB) to measure UL SINR as input for link adaption for resource scheduling.

### Configuring SRS

### WD Capability for SRS

The WD capability (UE capability) for SRS-ResourceId may be defined, e.g., in 3GPP Technical Specification (TS) 38.331.

SRS resource in RRC (the SRS resource-ID, not necessarily mapped to the order as specified in 38.101-1) for which the maximum is defined.

In TS 38.331 the SRS config related RRC signaling is defined as the following:
SRS-Config

The IE SRS-Config is used to configure sounding reference signal transmissions. The configuration defines a list of SRS-Resources, a list of SRS-PosResources, a list of SRS-PosResourceSets and a list of SRS-ResourceSets. Each resource set defines a set of SRS-Resources or SRS-PosResources. The network triggers the transmission of the set of SRS-Resources or SRS-PosResources using a configured aperiodicSRS-ResourceTrigger (L1 DCI). The network does not configure SRS specific power control parameters, alpha, p0 or pathlossReferenceRS if unifiedTCI-State Type is configured for the serving cell.

SRS-Config information element

-- ASN1START
-- TAG-SRS-CONFIG-START

| | |
|---|---|
| SRS-Config ::= | SEQUENCE { |
| srs-ResourceSetToReleaseList | SEQUENCE |

(SIZE(1..maxNrofSRS-ResourceSets)) OF SRS-ResourceSetId
OPTIONAL, -- Need N

| | |
|---|---|
| srs-ResourceSetToAddModList | SEQUENCE |

(SIZE(1..maxNrofSRS-ResourceSets)) OF SRS-ResourceSet
OPTIONAL, -- Need N

| | |
|---|---|
| srs-ResourceToReleaseList | SEQUENCE |

(SIZE(1..maxNrofSRS-Resources)) OF SRS-ResourceId
OPTIONAL, -- Need N

| | |
|---|---|
| srs-ResourceToAddModList | SEQUENCE |

(SIZE(1..maxNrofSRS-Resources)) OF SRS-Resource
OPTIONAL, -- Need N

| | |
|---|---|
| tpc-Accumulation | ENUMERATED {disabled} |

```
OPTIONAL, -- Need S
  ...,
  [[
```

| | |
|---|---|
| srs-RequestDCI-1-2-r16 | INTEGER (1..2) |

OPTIONAL, -- Need S

| | |
|---|---|
| srs-RequestDCI-0-2-r16 | INTEGER (1..2) |

OPTIONAL, -- Need S

| | |
|---|---|
| srs-ResourceSetToAddModListDCI-0-2-r16 | SEQUENCE |

(SIZE(1..maxNrofSRS-ResourceSets)) OF SRS-ResourceSet
OPTIONAL, -- Need N
srs-ResourceSetToReleseListDCI-0-2-r16 SEQUENCE
(SIZE(1..maxNrofSRS-ResourceSets)) OF SRS-ResourceSetId
OPTIONAL, -- Need N

| | |
|---|---|
| srs-PosResourceSetToReleaseList-r16 | SEQUENCE |

(SIZE(1..maxNrofSRS-PosResourceSets-r16)) OF SRS-PosResourceSetId-
r16
OPTIONAL, -- Need N

| | |
|---|---|
| srs-PosResourceSetToAddModList-r16 | SEQUENCE |

(SIZE(1..maxNrofSRS-PosResourceSets-r16)) OF SRS-PosResourceSet-
r16 OPTIONAL,-- Need N

| | |
|---|---|
| srs-PosResourceToReleaseList-r16 | SEQUENCE |

(SIZE(1..maxNrofSRS-PosResources-r16)) OF SRS-PosResourceId-r16
OPTIONAL, -- Need N

| | |
|---|---|
| srs-PosResourceToAddModList-r16 | SEQUENCE |

(SIZE(1..maxNrofSRS-PosResources-r16)) OF SRS-PosResource-r16
OPTIONAL -- Need N
]]
}
[...]
-- TAG-SRS-CONFIG-STOP
-- ASN1STOP
[...]

Periodic
Aperiodic, trigger of set
Antenna switching

For example, antenna switching may be used for sounding the DL channel for y WD (UE) receive antenna ports mapped to connectors by using reciprocity: SRS resources of x SRS T-ports amongst the said y R-ports, the receive antenna ports (connectors), some of which are also used for uplink transmissions of other physical channels. The configuration of each WD is based on the WD support of antenna switching configurations indicated as, e.g., t12r corresponding to xTyR with x=1 and y=2, single-port SRS transmissions across two receive antennas. In an SRS set used for antennas switching, the SRS resources with x SRS are mapped to x out of the y receive antenna ports.

### SRS Power Control and the Configured Maximum Power for SRS Transmission Occasions

The WD antenna gains may be included as part of the channel, and the output at the WD antenna connector is therefore important. Given a power headroom report and knowledge of the maximum WD Tx power, both referred to the WD antenna connector(s), the network node may estimate the pathloss from one or more SRS ports and thus the magnitude of the DL channel to each WD Rx antenna by reciprocity.

For SRS used for antenna switching all the receive ports (or connectors)R, the WD cannot deliver power according to the power class for all R connectors due to insertion loss, i.e., only for the antenna ports/connectors also used for UL transmissions of other physical channels such as PUSCH. This insertion loss may not be included in the receive path of the R connectors and specific to the switching procedure, and therefore may lead to estimation errors of the DL MIMO channel by the SRS resource set.

The power control for SRS transmissions in a transmission occasion i typically involves both open- and closed-loop control for carrier f, serving cell c and bandwidth part b,

$${P}_{SRS , b , f , c} ( i ) = min [ {P}_{CMAS , f , c} ( i ) , {P}_{0 , SRS , b , f , c} + {α}_{SRS , b , f , c} {PL}_{f , c} + 10 {log M}_{SRS , b , f , c} ( i ) + {h}_{b , f , c} ( i ) ]$$

where P_{0,SRS,b,f,c} is the target received power at the receiver (the network node, e.g., gNB in NR), PL_{f,c} the path-loss estimate with a weight factor α_{SRS,b,c,f} (the sum P_{0,SRS,b,f,c}+α_{SRS,b,f,c}PL_{f,c} the required output power per resource for open-loop control for SRS transmissions in bandwidth part b), M_{f,c} the allocated resource bandwidth for a transmission occasion, h_{b,f,c} (i) is the power-control adjustment state set according to configuration.

The output power as determined by open- and closed loop power may be limited by the maximum output power P_{CMAX,f,c} (i) configured (computed) by the WD for transmission occasion i. The configured P_{CMAX,f,c} (i) is specified for all types of transmissions (PUCCH, PUSCH and SRS). For SRS transmission occasions i the P_{CMAX,f,c} (i) includes the additional insertion losses for antenna connectors not normally used for UL transmissions.

The actual configured output power below the maximum can be estimated by the power headroom PH reported in a Type 3 PHR for SRS, e.g.:

$$PH = {P}_{CMAS , f , c} ( i ) - {P}_{SRS , b , f , c} ( i )$$

For example, a value PH>0 yields the actual output power of an SRS resource with parameters give for the SRS set containing the resource. PH<0 indicates that the configured power exceeds the maximum, the SRS resource is then transmitted at maximum. Standard Type 3 PHR is based on the SRS transmission (actual or reference) according to higher layer signaling of periodic/semi-persistent SRS transmission and downlink control information received by the WD up till the time a PDCCH for a new transmission that accommodate the PHR was monitored since the PHR was triggered (a similar procedure if PHR is included in a PUSCH triggered by a configured grant).

The plane of reference for the SRS output power P_{SRS,b,f,c} (i) is the antenna connector(s). For antenna switching this means that the WD sets the level P_{SRS,b,f,c} (i) at each connector sounded thus compensating for the additional insertion loss, the parameters of the power common are common for all resources of the SRS set. The insertion loss may not be fully accounted for in implementations: verification of the absolute power level in device testing allows a tolerance of the order of ±10 dB when measured below the maximum power, which would also conceal inaccurate power configurations at connectors (the tolerance for measurements at maximum power setting is much smaller). The said insertion loss will always be observed at the maximum power setting (limits the maximum power per port) notwithstanding any account of the loss at lower power levels.

The plane of reference for the DL PL and the RSRP is also the antenna connectors. 3GPP TS 38.215, for example, specifies that the reference point for e.g. SS-RSRP is:

“For frequency range 1, the reference point for the SS-RSRP shall be the antenna connector of the UE. For frequency range 2, SS-RSRP shall be measured based on the combined signal from antenna elements corresponding to a given receiver branch. For frequency range 1 and 2, if receiver diversity is in use by the UE, the reported SS-RSRP value shall not be lower than the corresponding SS-RSRP of any of the individual receiver branches.”

The above quotation implies that all connectors may be used for the measured PL. For SRS in particular, the PL reference is then the same for all ports sounded (all transmission occasions of SRS resources in the set).

The P_{CMAX,f,c} (i) accounts for:
the power class P_{Powerclass} and any power class fallback ΔP_{Powerclass} applied;
power back-off, MPR, A-MPR and P-MPR;
insertion loss due to, e.g., front-filters; and/or
for SRS additional insertion loss ΔT_{RxSRS} (maximum allowed) for connectors not used for PUSCH and PUCCH transmissions.

For SRS transmission occasions: maximum permitted insertion loss per R connector sounded is up to ΔT_{RxSRS}=7.5 dB on any one of the R connectors. The actual loss is implementation specific. The trace loss may be known by the WD at least for connectors used for UL transmissions of all physical channels. The same maximum permitted insertion loss applies for 2-port SRS (split between two ports).

The relaxation ΔT_{RxSRS} is not allowed for the first SRS transmission in the SRS set, which is assumed to use the connector(s) for UL transmissions.

An excerpt from the specification 3GPP TS 38.101-1 clause 6.2.4 is reproduced below:

### 6.2.4 Configured Transmitted Power

The UE is allowed to set its configured maximum output power P_{CMAX,f,c} for carrier f of serving cell c in each slot. The configured maximum output power P_{CMAX,f,c} is set within the following bounds:

$${P}_{CMAX \_ L , f , c} \leq {P}_{CMAX , f , c} \leq {P}_{CMAX \_ H , f , c}$$

$$with$$

$${P}_{CMAX \_ L , f , c} = MIN \{ {P}_{EMAX , c} - {Δ T}_{C , c} , ( {P}_{PowerClass} - {Δ P}_{PowerClass} ) - MAX ( MAX ( {MPR}_{c} + {Δ MPR}_{c} , A - {MPR}_{c} ) + {Δ T}_{IB , c} + {Δ T}_{C , c} + {Δ T}_{RxSRS} , P - {MPR}_{c} ) \}$$

$${P}_{CMAX \_ H , f , c} = MIN \{ {P}_{EMAX , c} , {P}_{PowerClass} - {Δ P}_{PowerClass} \}$$

where
[ . . . ]
ΔT_{RxSRS} is applied during SRS transmission occasions with usage in SRS-ResourceSet set as ‘antennaSwitching’ when
a) UE transmits SRS on the second SRS resource in every configured SRS resource set when the SRS-TxSwitch capability is indicated as ‘t1r2’ or ‘t1r1-t1r2’
b) UE transmits SRS on the second, third and fourth SRS resources of the total 4 SRS resources from all configured SRS resource set(s) consisting of one SRS port when the SRS-TxSwitch capability is indicated as ‘t1r4’ or, ‘t1r4-t2r4’ or ‘t1r1-t1r2-t1r4’ or, ‘t1r1-t1r2-t2r2-t1r4-t2r4’
c) UE transmits SRS from the second SRS port pair on the second SRS resource in every configured SRS resource set consisting of two SRS ports when the SRS-TxSwitch capability is indicated as ‘t2r4’ or ‘t1r4-t2r4’, or ‘t1r1-t1r2-t2r2-t2r4’ or ‘t1r1-t1r2-t2r2-t1r4-t2r4’, or
d) UE transmits SRS to a DL-only carrier

The value of ΔT_{RxSRS} is 4.5 dB for bands whose F_{UL_high} is higher than the F_{UL_low} of n79 and 3 dB for bands whose F_{UL_high} is lower than the F_{UL_low} of n79 when the device is capable of power class 3 or power class 5 or power class 1.5 in the band, or when the device is capable of power class 2 in the band and ΔP_{PowerClass}=3 dB, or when UE indicating txDiversity-r16.

The value of ΔT_{RxSRS} is 7.5 dB for bands whose F_{UL_high} is higher than the F_{UL_low} of n79 and 6 dB for bands whose F_{UL_high} is lower than the F_{UL_low} of n79 during SRS transmission occasions with configured SRS resources consisting of one SRS port when the device is capable of power class 2 in the band and ΔP_{PowerClass}=0 dB and not indicating txDiversity-r16.

For other SRS transmissions ΔT_{RxSRS} is zero;

The WD behavior for SRS is defined in 3GPP TS 38.213, reproduced below:

### 7.3 Sounding Reference Signals

For SRS, a UE splits a linear value \hat{P}_{SRS,b,f,c} (i, qₛ, l) of the transmit power P_{SRS,b,f,c} (i, qₛ, l) on active UL BWP b of carrier f of serving cell c equally across the configured antenna ports for SRS.

### 7.3.1 UE Behavior

If a UE transmits SRS based on a configuration by SRS-ResourceSet on active UL BWP b of carrier f of serving cell c using SRS power control adjustment state with index l, the UE determines the SRS transmission power P_{SRS,b,f,c} (i, qₛ, l) in SRS transmission occasion i as

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( i ) ) + {PL}_{b , f , c}^{( p )} ( {q}_{d} ) + {h}_{b , f , c} ( i , l )\end{matrix} \} [ dBm ]$$

where,
P_{CMAX,f,c} (i) is the UE configured maximum output power defined in [8, TS 38.101-1], [8-2, TS 38.101-2] and [TS 38.101-3] for carrier f of serving cell c in SRS transmission occasion i
P_{O_SRS,b,f,c} (qₛ) is provided by p0 for active UL BWP b of carrier f of serving cell c and SRS resource set qₛ provided by SRS-ResourceSet and SRS-ResourceSetId
M_{SRS,b,f,c} (i) is a SRS bandwidth expressed in number of resource blocks for SRS transmission occasion i on active UL BWP b of carrier f of serving cell c and μ is a SCS configuration defined in [4, TS 38.211]
α_{SRS,b,f,c} (qₛ) is provided by alpha for active UL BWP b of carrier f of serving cell c and SRS resource set qₛ
PL_{b,f,c} (q_{d}) is a downlink pathloss estimate in dB calculated by the UE using RS resource index q_{d} as described in clause 7.1.1 for the active DL BWP of serving cell c and SRS resource set qₛ [6, TS 38.214]. The RS resource index q_{d} is provided by pathlossReferenceRS associated with the SRS resource set qₛ and is either an ssb-Index providing a SS/PBCH block index or a csi-RS-Index providing a CSI-RS resource index. If the UE is provided enablePL-RS-UpdateForPUSCH-SRS, a MAC CE [11, TS 38.321] can provide by SRS-PathlossReferenceRS-Id a corresponding RS resource index q_{d} for aperiodic or semi-persistent SRS resource set qₛ
   If the UE is not provided pathlossReferenceRS or SRS-PathlossReferenceRS-Id, or before the UE is provided dedicated higher layer parameters, the UE calculates PL_{b,f,c} (q_{d}) using a RS resource obtained from an SS/PBCH block with same SS/PBCH block index as the one the UE uses to obtain MIB
   If the UE is provided pathlossReferenceLinking, the RS resource is on a serving cell indicated by a value of pathlossReferenceLinking
   If the UE
      is not provided pathlossReferenceRS or SRS-PathlossReferenceRS-Id,
      is not provided spatialRelationInfo, and
      is provided enableDefaultBeamPL-ForSRS, and
      is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [5, TS 38.212]
[ . . . ]

According to 3GPP TS 38.213, reproduced below, the power headroom report Type 3 is defined as follows:

### 7.7.3 Type 3 PH Report

If a UE determines that a Type 3 power headroom report for an activated serving cell is based on an actual SRS transmission then, for SRS transmission occasion i on active UL BWP b of carrier f of serving cell c and if the UE is not configured for PUSCH transmissions on carrier f of serving cell c and the resource for the SRS transmission is provided by SRS-Resource, the UE computes a Type 3 power headroom report as

$${PH}_{type 3 , b , f , c} ( i , ) = {P}_{CMAX , f , c} ( i ) - \{ {P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( i ) ) + {PL}_{b , f , c} ( {q}_{d} ) + {h}_{b , f , c} ( i , l ) \} [ dB ]$$

where P_{CMAX,f,c} (i), P_{O_SRS,b,f,c} (qₛ), M_{SRS,b,f,c} (i), α_{SRS,b,f,c}(qₛ), PL_{b,f,c} (q_{d}) and h_{b,f,c} (i) are defined in clause 7.3.1 with corresponding values provided by SRS-ResourceSet.

If the UE determines that a Type 3 power headroom report for an activated serving cell is based on a reference SRS transmission then, for SRS transmission occasion i on UL BWP b of carrier f of serving cell c, and if the UE is not configured for PUSCH transmissions on UL BWP b of carrier f of serving cell c and a resource for the reference SRS transmission is provided by SRS-Resource, the UE computes a Type 3 power headroom report as

$${PH}_{type3 , b , f , c} ( i , ) = {\tilde{P}}_{CMAX , f , c} ( i ) - \{ {P}_{O \_ SRS , b , f , c} ( {q}_{s} ) + {α}_{SRS , b , f , c} ( i ) ) + {PL}_{b , f , c} ( {q}_{d} ) + {h}_{b , f , c} ( i , l ) \} [ dB ]$$

where qₛ is an SRS resource set corresponding to SRS-ResourceSetId=0 for UL BWP b and P_{O_SRSb,f,c} (qₛ), α_{SRS,f,c} (qₛ), PL_{b,f,c} (q_{d}) and h_{b,f,c} (1) are defined in clause 7.3.1 with corresponding values obtained from SRS-ResourceSetId=0 for UL BWP b. \tilde{P}_{CMAX,f,c} (i) is computed assuming MPR=0 dB, A-MPR=0 dB, P-MPR-0 dB and DT_{C}=0 dB. MPR, A-MPR, P-MPR and DT_{C} are defined in [3GPP TS 38.101-1], [3GPP TS 38.101-2] and [3GPP TS 38.101-3].

If a UE is configured with two UL carriers for a serving cell and the UE determines a Type 3 power headroom report for the serving cell based on a reference SRS transmission and a resource for the reference SRS is provided by SRS-Resource, the UE computes a Type 3 power headroom report for the serving cell assuming a reference SRS transmission on the UL carrier provided by pucch-Config. If pucch-Config is not provided to the UE for any of the two UL carriers, the UE computes a Type 3 power headroom report for the serving cell assuming a reference SRS transmission on the non-supplementary UL carrier.

Thus, in some existing systems, the output power for the R ports may only be known within a wide range (up to about 7 dB, not including the MPR uncertainty). This may lead to estimation errors due to uncertain SRS output power (unknown insertion loss on R-ports, only that based on the maximum allowed insertion loss and by unknown PA/power-class configuration)

In some existing works (e.g., as described in 3GPP R1-2112201), it has been suggested that “the UE can report to the network the power offset between the antenna ports which can help the network to compensate the UL/DL channel mismatch.” Reporting a power offset between antenna ports corresponding to Tx and Rx chains as a WD capability, as in 3GPP R1-2112201, may limit the WD implementation and the ability of the network node to infer DL CSI from UL measurements. If the capability indicates a maximum additional loss, e.g., X dB, in a receive path relative to a transmit path, the network node does not know if the loss is X dB or something less.

In general, the ratio between the transmitted power on the ‘Rx’ ports may not be fixed in time. If the transmit power is less than Pcmax-X dB, then the WD should transmit each RX port at the same power (determined by power control), and therefore may lower the transmit power of a primary Rx port to match the power of a secondary (more lossy) Rx port. In this case, the relative power transmitted on the ‘Rx ports’ can be zero, and the network node (e.g., gNB) may directly estimate the relative power of these ports from the SRS. However, at powers greater than Pcmax-X, the WD may transmit more power on the primary Rx port to compensate power limitations on the secondary Rx port. The amount of power difference is not known to the network since there is no way to signal it directly in 3GPP Rel-18. Furthermore, if new WD capability signaling were to indicate a maximum value for the power difference, this again is a maximum, rather than the actual value of the power difference at any point in time. Even if new WD capability signaling were to indicate the actual value of the power difference between different Rx ports, the behavior of WD on compensating power limitations is not known to the network.

The mapping between Tx chains and ‘Rx’ ports is a WD implementation-level feature and may vary in time. Therefore, the relative power of an Rx port to a reference port can vary (as long as it meets the ΔT_{RxSRS} configured power requirements).

Therefore, there is a need for a mechanism that allows the network node to determine the relative transmitted power of an Rx port to a reference Rx port.

Standard Type 3 PHR reporting configurations are based on the configured power and the output power configured for the entire SRS resource set, not its resources, for which the maximum configured power and PH vary.

Thus, existing systems lack appropriate configurations for supporting SRS-configured maximum power.

### SUMMARY

Some embodiments advantageously provide methods, systems, and apparatuses for supporting configurations for SRS-configured maximum power.

In some embodiments, the configured maximum power, the SRS power headroom, and any (SRS) power-class fallback is reported for each SRS resource in an SRS resource set. This may allow SRS power estimation both below and at the maximum power level for the SRS port(s) for both single-port and multi-port SRS transmissions.

In some embodiments, the report may be included in a MAC-CE element sent by the WD upon request by the network node or triggered (e.g., based on timers and events). The values reported are mapped to SRS resource ID(s) as configured by the network node, where the order of SRS transmissions may depend on the time-domain configuration of each SRS resource ID.

In some embodiments, the power control for SRS used for antenna switching may be modified (e.g., by the WD and/or network node), such that output power is configured per SRS resource and port(s): the PL may be estimated per SRS port(s) sounded for improved open loop control and the output power per port modified by an offset for the R port relative to a reference port (such as that used for other UL) may be used to account for additional insertion losses of ports not normally used for the UL. This may improve the PH report for each SRS resource of the SRS set reported, as compared to existing systems and configurations.

Embodiments of the present disclosure may provide one or more of the following advantages, e.g., over some existing systems and configurations:

Estimation of the MIMO channel and thus CSI for DL may be improved by knowledge of the actual power used for the SRS transmissions on the SRS port(s) of each SRS resource in the SRS resource set by means of the MAC-CE report. This may not be possible with current Type 3 PHR signaling.

The report of the PH per SRS resource may also include any effect of changed PL estimations (open loop power setting) between transmission occasions of SRS resources.

The accuracy of the PH may be improved since the power control for SRS may be based on each SRS resource rather that the entire SRS set. Any insertion loss during switching may be included in the PH for all power levels (e.g., not only at a maximum).

Embodiments of the present disclosure may be less sensitive (e.g., compared to existing systems) to the actual PA power class used by the WD for the different R ports, as any power class change between SRS ports may be reported to the network node, which also may imply more implementation freedom for the WD. Thus, in some embodiments, the maximum power may be determinable/known regardless of actual power class used per port.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node for supporting configurations for SRS-configured maximum power according to some embodiments of the present disclosure; and

FIG. 8 is a flowchart of an exemplary process in a wireless device for supporting configurations for SRS-configured maximum power according to some embodiments of the present disclosure.

### DETAILED DESCRIPTION

Before describing in detail exemplary embodiments, it is noted that the embodiments reside primarily in combinations of apparatus components and processing steps related to supporting configurations for SRS-configured maximum power. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods, apparatuses, and systems for supporting configurations for SRS-configured maximum power.

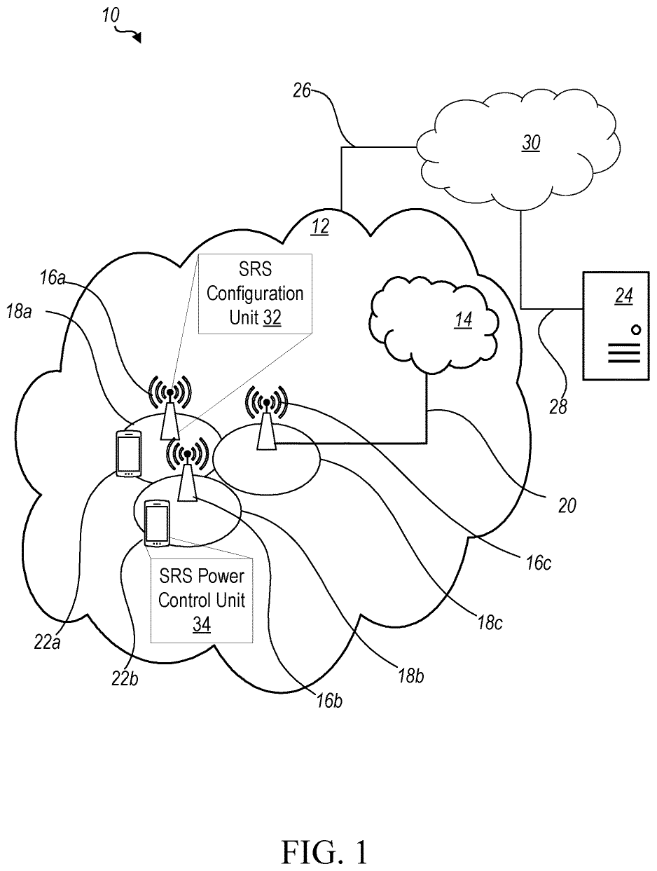

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a SRS Configuration unit 32 which is configured for supporting configurations for SRS-configured maximum power. A wireless device 22 is configured to include an SRS Power Control unit 34 which is configured for supporting configurations for SRS-configured maximum power.

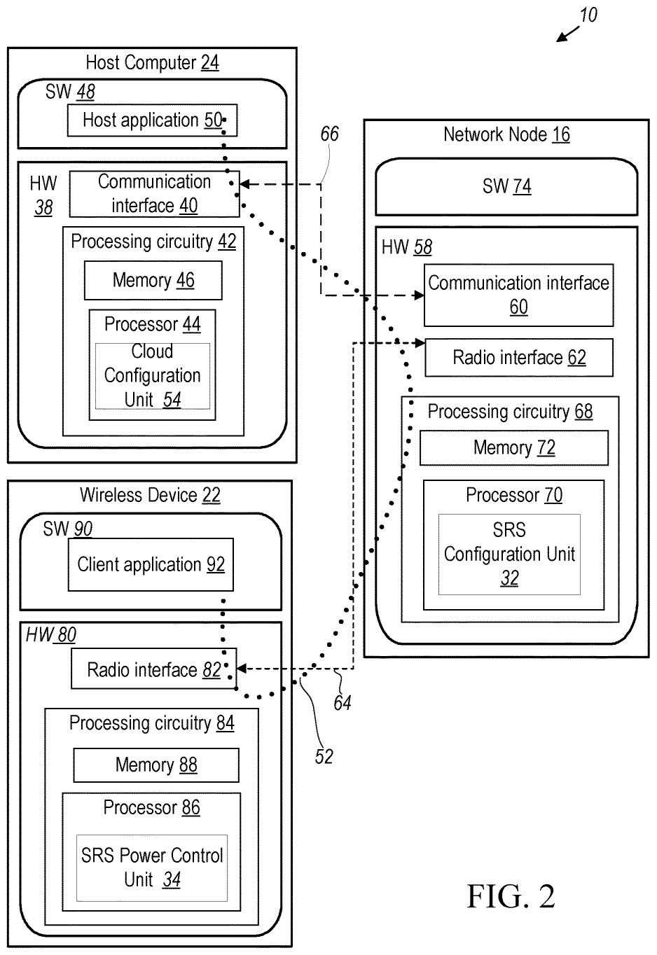

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Cloud Configuration unit 54 configured to enable the service provider to observe/monitor/control/transmit to/receive from/configure/etc. the network node 16 and or the wireless device 22, e.g., for supporting configurations for SRS-configured maximum power.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include SRS Configuration unit 32 configured for supporting configurations for SRS-configured maximum power.

The communication system 10 further includes the WD 22 already referred to. The WD 22 may have hardware 80 that may include a radio interface 82 configured to set up and maintain a wireless connection 64 with a network node 16 serving a coverage area 18 (coverage area 18 is also referred to herein as a cell 18) in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an SRS Power Control unit 34 configured for supporting configurations for SRS-configured maximum power.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as SRS Configuration unit 32, and SRS Power Control unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

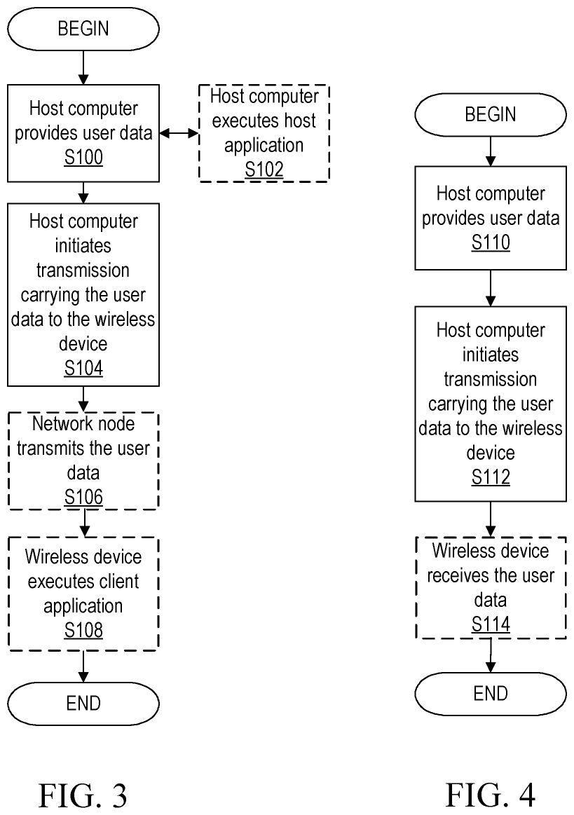

FIG. 4 is a flowchart illustrating an exemplary method implemented in a communication system, such as, for example, the communication system of FIG. 1, in accordance with one embodiment. The communication system may include a host computer 24, a network node 16 and a

WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

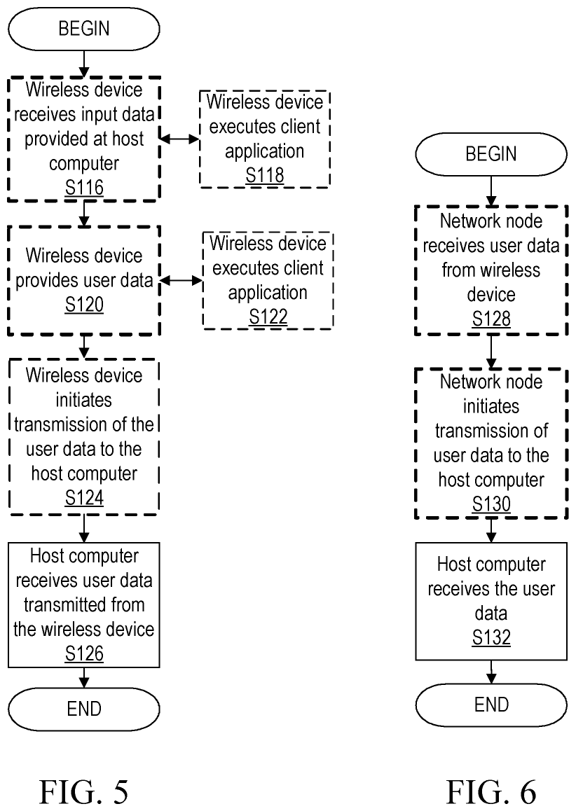

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

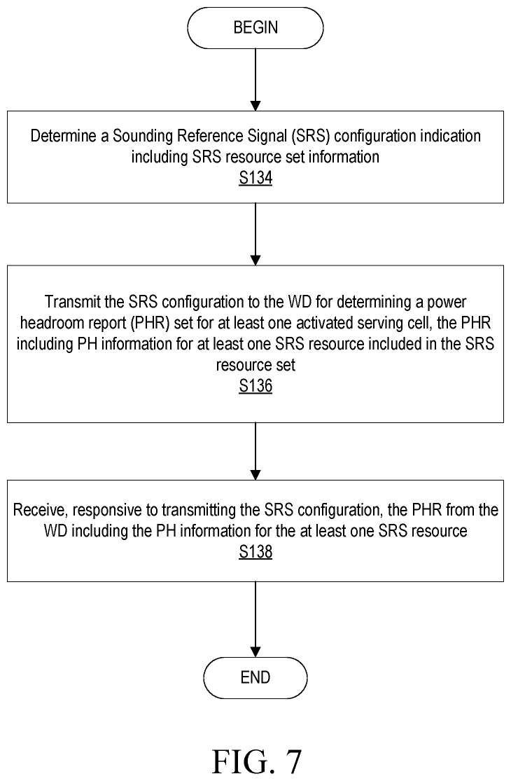

FIG. 7 is a flowchart of an exemplary process in a network node 16 for supporting configurations for SRS-configured maximum power. One or more blocks described herein may be performed by one or more elements of network node 16 such as by one or more of processing circuitry 68 (including the SRS Configuration unit 32), processor 70, radio interface 62 and/or communication interface 60. Network node 16 is configured to determine (Block S134) a Sounding Reference Signal (SRS) configuration indication including SRS resource set information. Network node 16 is configured to transmit (Block S136) the SRS configuration to the WD 22 for determining a power headroom report (PHR) set for at least one activated serving cell 18, the PHR including PH information for at least one SRS resource included in the SRS resource set. Network node 16 is configured to receive (Block S138), responsive to transmitting the SRS configuration, the PHR from the WD 22 including the PH information for the at least one SRS resource.

In some embodiments, the network node 16 is further configured to receive the SRS from the WD 22 according to the PHR, wherein the PHR including PH information for at least one SRS resource is determined by an SRS transmission power for the at least one SRS resource. In some embodiments, the SRS configuration indicates information for determining the SRS transmission power for at least one antenna port of a plurality of antenna ports of the WD 22, where the SRS transmission power is determined to be a smaller value between a first transmission power and a second transmission power. The first transmission power may correspond to a maximum value of transmission power of the at least one antenna port. The second transmission power may correspond to a configurable parameter (e.g., configurable by the network node 16, which may be based on a determination made at the network node 16) which may be based on a per-port SRS power control capability of the WD; and/or additional insertion loss for antenna ports not used for PUSCH and/or PUCCH transmission of the at least one antenna port. The receiving of the SRS may further include receiving the SRS from at least one of the plurality of antenna ports of the WD 22 based on the determined transmission power for the at least one antenna port.

The per-port SRS power control capability is a UE capability that is reported from the WD to the network node.

The configuration of the parameter on a per-port SRS power control capability of the WD may be variable and may apply for example per SRS transmission occasion.

Each SRS transmission occasion is defined as following:

A PUSCH/PUCCH/SRS/PRACH transmission occasion i is defined by a slot index

$${n}_{s , f}^{μ}$$

within a frame with system frame number SFN, a first symbol S within the slot, and a number of consecutive symbols L.

When SRS is transmitted with the configured SRS resource, the determined transmission power for each SRS transmission occasion can vary for each SRS transmission occasion.

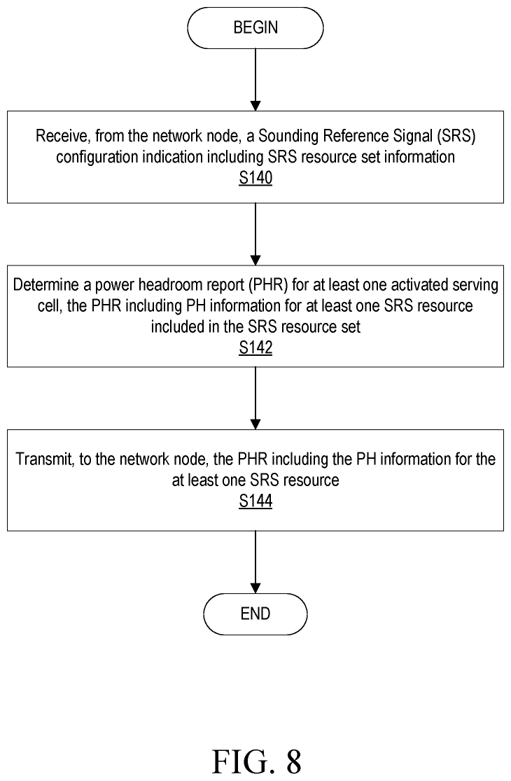

An SRS transmission occasion is always a transmission occasion on its own in view of other transmission occasions.FIG. 8 is a flowchart of an exemplary process in a wireless device 22 according to some embodiments of the present disclosure for supporting configurations for SRS-configured maximum power. One or more blocks described herein may be performed by one or more elements of wireless device 22 such as by one or more of processing circuitry 84 (including the SRS Power Control unit 34), processor 86, radio interface 82 and/or communication interface 60. Wireless device 22 is configured to receive (Block S140), from the network node 16, a Sounding Reference Signal (SRS) configuration indication including SRS resource set information. Wireless device 22 is configured to determine (Block S142) a power headroom report (PHR) set for at least one activated serving cell 18, the PHR including PH information for at least one SRS resource included in the SRS resource set. Wireless device 22 is configured to transmit (Block S144), to the network node, the PHR including the PH information for the at least one SRS resource.

In some embodiments, determining the PHR for the at least one SRS resource includes determining PH information for each SRS resource included in the SRS resource set by determining an SRS transmission power for each SRS resource, and the WD 22 is further configured to transmit the SRS to the network node 16 with the determined SRS transmission power.

In some embodiments, WD 22 is configured to receive (Block S140), from the network node 16, an SRS configuration indication including SRS resource set information. The WD 22 determines SRS transmission power for each antenna port of a plurality of antenna ports of the WD 22 based on the SRS configuration information, the SRS transmission power being determined to be a smaller value between a first transmission power and a second transmission power, the first transmission power corresponding to a maximum value of transmission power of the at least one antenna port, and the second transmission power corresponding to at least one of a configurable parameter based on a per-port SRS power control capability of the WD, and/or additional insertion loss for antenna ports not used for PUSCH and/or PUCCH transmission of the at least one antenna port. The WD 22 transmits the SRS on at least one of the plurality of antenna ports of the WD 22 based on the determined transmission power for the at least one antenna port.

Having described the general process flow of arrangements of the disclosure and having provided examples of hardware and software arrangements for implementing the processes and functions of the disclosure, the sections below provide details and examples of arrangements for supporting configurations for SRS-configured maximum power.

In some embodiments, rather than reporting the actual difference in the Tx insertion loss amongst “T” and “R” connectors for WDs 22 configured with SRS transmissions used for antenna switching, instead, one or more of the following may apply:
the power headroom (PH) may be reported for each SRS resource in the set indicating the actual output power also below the maximum power, which may also account for any insertion loss (e.g., the output power set at the antenna connector(s)) and variation of the PL between SRS transmissions; and
the configured maximum output power that includes the insertion loss may be reported and/or utilized, e.g., the maximum power attainable at the connector, the reference for the PH, which may also include any power-class fallback for a specific SRS resource, if used.

In some embodiments, for each resource in the SRS set, the WD 22 may be configured to determine and reports in a MAC-CE the configured maximum power for each SRS resource in the SRS resource set with dB granularity, the power-class fallback (if applicable), and the power headroom. The actual insertion loss for each connector associated with an SRS port may be included in the configured maximum power.

In some embodiments, signaling and/or configuration information (e.g., via the MAC, via signaling from the network node 16, via stored configuration information, etc.) may configure/instruct the WD 22 to include a report after the first SRS transmission of the resource set, following the trigger, of the reported values based on the most recent transmission of the SRS resource set.

In some embodiments, triggering of the report need not be frequent, e.g., following configuration of SRS in the UL BWP, triggered by timers in the event of reconfiguration of SRS power-control parameters for the SRS resource set, or following changes of the SRS port to antenna-connector mapping by the WD 22 (e.g., because the SRS resource mapping to physical WD 22 antenna elements is not necessarily constant). The network node may also be configured to trigger a report, e.g., by indication in the DCI or other signaling.

In some embodiments, the SRS power control for antenna switching may be augmented to further improve the above PH reporting and/or the DL CSI estimation, as follows:

Step 1. Configure SRS for antenna switching with enhanced reporting of actual SRS maximum power including any fallback and power headroom per SRS port

The report (WD 22 to network node 16) contains a Resource set with a list of SRS resources with different cyclic shifts (each mapped to antenna receive port with its connectors) and the corresponding Pcmax and power headroom referred to the antenna connector, e.g., according to the power control for SRS specified in 38.213.

Step 1a. Triggering the report:

The report may be triggered by one or more of:
expiration of timers (including a “prohibit” timer” to reduce reporting frequency);
modification of the SRS configuration (e.g., by network node 16, by WD 22, etc.);
modification of a WD 22 mapping of SRS ports to physical antenna connectors; and/or
by DCI, e.g., when the MAC receives a PDCCH triggering an SRS transmission/report.

Step 2. In some embodiments, the WD 22 is configured to report the SRS power (single entry or multi-entry if SRS reporting on multiple UL cells 18) based on the most recent transmission of the SRS set or resource.

Step 2a. Some embodiments include configurations for MAC-CE formats and parameters, e.g., single-entry report for a single serving cell 18, e.g.:

Single-entry MAC-CE: list of SRS-ResourceSetID, for each SRS resource ID the Pcmax,f,c for SRS transmission occasions, either a “reference value” (MPR=0 dB) or “actual” with MPR (if only reference then fewer octets needed), the PH for each resource and DPPowerclass if applied for the resource.

Step 2b. Some embodiments include configurations for MAC-CE format and parameters, multiple-entry with multiple UL serving cells 18 configured (antenna switching within one or more UL cell 18), e.g.:

Multi-entry MAC-CE with cell-id in addition and a SRS resource set list per cell 18.

Step 3. In some embodiments, the SRS power control specified per resource set may be according to a Rel-17 version of 38.213, for example.

Step 4. In some embodiments, SRS power control may be enhanced by accounting for additional insertion loss for a port not used for PUSCH and PUCCH transmissions and the PL measured, e.g., at each port sounded.

The SRS power control in 3GPP TS 8.213 clause 7.3.1 is reproduced below:

### 7.3.1 UE Behavior

If a UE transmits SRS based on a configuration by SRS-ResourceSet on active UL BWP b of carrier f of serving cell 18 c using SRS power control adjustment state with index l, the UE determines the SRS transmission power P_{SRS,b,f,c} (i, qₛ, l) in SRS transmission occasion i as

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( i ) ) + {PL}_{b , f , c}^{( p )} ( {q}_{d} ) + {h}_{b , f , c} ( i , l )\end{matrix} \} [ dBm ]$$

modified as follows for SRS transmissions of resources in an SRS set used for antenna switching, for each antenna port or antenna ports p,

$${P}_{SRS , b , f , c}^{( p )} ( i , {q}_{s} , l ) == min \{ \begin{matrix}{P}_{CMAX , f , c}^{( p )} ( i ) , \\ {P}_{{0}_{SRS} , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c}^{( p )} ( {q}_{d} ) + {h}_{b , f , c} ( i , l ) + \\ {β}_{SRS , b , f , c} ( {q}_{s} ) ( {\tilde{P}}_{CMAX , f , c}^{( p )} - {\tilde{P}}_{CMAX , f , c}^{( {p}_{0} )} )\end{matrix}$$

with

$${PL}_{b , f , c}^{( p )} ( {q}_{d} ) = referenceSignalPower$$

higher layer filtered RSRPₚ the higher-layered filtered value for port p as measured on the antenna connectors mapped to SRS port p with p indexing one or more SRS ports according to the number of SRS ports of the SRS resource
RSRPₚ the RSRP measured for the connectors mapped to the SRS port(s) p

$$( {\tilde{P}}_{CMAX , f , c}^{( p )} - {\tilde{P}}_{CMAX , f , c}^{( {p}_{0} )} )$$

the additional insertion loss for ports not used for PUSCH/PUCCH transmissions, the ratio of the configured maximum power for a reference transmission (MPR=A-MPR=P-MPR=0 dB and only including the additional insertion loss for antenna switching) in relation to a reference port (or ports) p₀. The latter can be ports used for PUSCH/PUSCH for which the relaxation the ΔT_{RxSRS} is not allowed.
β_{SRS,b,f,c} (qₛ) a configurable parameter based on support of the per-port SRS power control UE capability.

The actual insertion loss in the allowed range up to ΔT_{RxSRS} is equal to

$$( {\tilde{P}}_{CMAX , f , c}^{( p )} - {\tilde{P}}_{CMAX , f , c}^{( {p}_{0} )} )$$

for reference SRS transmissions.

$${\tilde{P}}_{CMAX , f , c}^{( p )}$$

is the configured maximum power for SRS transmission occasions on the port(s) p.

Step 5. In some embodiments, the Steps 1, 2 and 3 described above may be applied for switching between multiple UL serving cells 18 including PUSCH-less carriers.

One or more embodiments of the present disclosure may be described by one or more of the following non-limiting examples:

Example AA1. A method for reporting power headroom (PH) for a sounding reference signal (SRS) in a wireless communication system, implemented in and/or performed by a WD (e.g., User Equipment (UE)), including:
receiving (e.g., from a network node) Sounding Reference Signal (SRS) configuration information including at least information on SRS resource set;
determining a power headroom report (PHR) set for at least one activated serving cell based on SRS transmission and wherein the WD is not configured for Physical Uplink Shared Channel (PUSCH) transmission, including:
   computing a PHR for each SRS resource comprised in the SRS resource set; and
reporting (e.g., to a network node) the PH for each SRS resource comprised in the SRS resource set.

Example AA1 (a). A method for reporting power headroom (PH) for a sounding reference signal (SRS) in a wireless communication system, implemented in and/or performed by a WD (e.g., User Equipment (UE)), including:
receiving (e.g., from a network node) Sounding Reference Signal (SRS) configuration information including at least information on SRS resource set;
determining a power headroom report (PHR) set for at least one activated serving cell based on SRS transmission and wherein the WD is configured for Physical Uplink Shared Channel (PUSCH) transmission, including:
   computing a PHR for each SRS resource comprised in the SRS resource set; and
reporting (e.g., to a network node) the PH for each SRS resource comprised in the SRS resource set.

Example AA2. The method according to Example AA1, wherein computing the PHR for each SRS resource comprised in the SRS resource set further includes:
determining an SRS transmission power for each SRS resource for the PHR; and
transmitting the SRS (e.g., to the network node) with the determined transmission power.

Example AA3. The method according to Example AA2, wherein determining the SRS transmission power for each SRS resource comprised in the SRS resource set further includes:
determining the SRS transmission power for each antenna port of a plurality of antenna ports of the WD based on the SRS configuration information;
wherein the SRS transmission power is determined to be a smaller value between a first transmission power and a second transmission power, and
   wherein the first transmission power is based on a maximum value of transmission power of the at least one antenna port; and
   the second transmission power is calculated (or precalculated) transmission power based on at least one of the following:
      a configurable parameter based on WD capability (e.g., UE capability) of per-port SRS power control; and/or
      additional insertion loss for antenna ports not used for PUSCH or PUCCH transmission of the at least one antenna port; and
transmitting SRS (e.g., to the network node) by at least one of the plurality of antenna ports of the WD based on the determined transmission power for the at least one antenna port.

Example AA4. The method according to any one of Examples AA1-AA3, wherein reporting PHR for each SRS resource is triggered by at least one of the following conditions:
expiration of timers;
modification of the SRS configuration;
modification of a WD mapping of SRS ports to physical antenna connectors; and
by DCI: when the MAC receives a PDCCH triggering an SRS transmission/report.

Example AA5. The method according to Example AA4, wherein the intensity of reporting of PH for each SRS resource is limited by expiration of a prohibit timer.

Example AA6. A method according to any one of Examples AA1-AA5, wherein the reporting the PH further comprises:
Reporting the PH by media access control (MAC)-control element (CE), wherein the MAC CE comprises:
   At least one PH field, wherein the at least one PH field indicates the corresponding one of the following:
      activated serving cell; and/or
      configured band combination with at least one activated serving cell.

Example AA7. The method according to Example AA6, wherein the MAC CE comprises the corresponding one of the following:
single entry indicating an activated serving cell; and/or
multiple entries indicating more than one activated serving cells.

Example AA8. The method according to any one of Examples AA6 and AA7, wherein at least one entry comprised in the MAC CE includes an SRS Resource ID and the corresponding one of the following:
Pcmax for the SRS resource ID;
Power class fallback value for the SRS resource ID; and/or
PH for the SRS resource ID.

Example AA9. The method according to any one of Examples AA1-AA8, wherein the WD is transmitting SRS by switching the antenna ports with the determined transmission power for the antenna port transmitting the SRS.

Example AA10. The method according to any one of Examples AA1-AA9, wherein the WD is configured for transmitting the SRS based on the SRS configuration information with the SRS resource ID on the antenna port by the determined transmission power for the antenna port.

Example BB1. A method for transmitting sounding reference signal (SRS) in a wireless communication system, performed by a WD (e.g., User Equipment (UE)), the method including:
receiving (e.g., from a network node) SRS configuration information including at least information on SRS resource set;
determining SRS transmission power for each antenna port of a plurality of anten
na ports of the WD based on the SRS configuration information, wherein the SRS transmission power is determined to be a smaller value between a first transmission power and a second transmission power, wherein:
   the first transmission power is based on a maximum value of transmission power of the at least one antenna port; and
   the second transmission power is a calculated (or precalculated) transmission power based on at least one of the following:
      a configurable parameter based on WD capability (e.g., UE capability) of per-port SRS power control; and/or
      additional insertion loss for antenna ports not used for PUSCH or Physical Uplink Control Channel (PUCCH) transmission of the at least one antenna port; and
transmitting SRS (e.g., to the network node) by at least one of the plurality of antenna ports of the WD based on the determined SRS transmission power for the at least one antenna port.

Example BB2. The method according to Example BB1, wherein the WD is transmitting SRS by switching the antenna ports with the determined SRS transmission power for the antenna port transmitting the SRS.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EMBODIMENTS

Embodiment A1. A network node configured to communicate with a wireless device (WD), the network node configured to, and/or comprising a radio interface and/or comprising processing circuitry configured to:
determine a Sounding Reference Signal (SRS) configuration indication including SRS resource set information;
transmit the SRS configuration to the WD for determining a power headroom report (PHR) set for at least one activated serving cell, the PHR including PH information associated with at least one SRS resource included in the SRS resource set; and
receive, responsive to transmitting the SRS configuration, the PHR from the WD including the PH information for the at least one SRS resource.

Embodiment A2. The network node of Embodiment A2, wherein the network node is further configured to receive the SRS from the WD according to the determined SRS transmission power and/or the PHR.

Embodiment A3. The network node of Embodiment A2, wherein:
the SRS configuration indicates information for determining the SRS transmission power for each antenna port of a plurality of antenna ports of the WD, the SRS transmission power being determined to be a smaller value between a first transmission power and a second transmission power, the first transmission power corresponding to a maximum value of transmission power of the at least one antenna port, and the second transmission power corresponding to at least one of:
   a configurable parameter based on a per-port SRS power control capability of the WD; and/or
   additional insertion loss for antenna ports not used for PUSCH or PUCCH transmission of the at least one antenna port; and
the receiving of the SRS further includes receiving the SRS from at least one of the plurality of antenna ports of the WD based on the determined transmission power for the at least one antenna port.

Embodiment B1. A method implemented in a network node, the method comprising:
determining a Sounding Reference Signal (SRS) configuration indication including SRS resource set information;
transmitting the SRS configuration to the WD for determining a power headroom report (PHR) set for at least one activated serving cell, the PHR including PH information associated with at least one SRS resource included in the SRS resource set; and
receiving, responsive to transmitting the SRS configuration, the PHR from the WD including the PH information for the at least one SRS resource.

Embodiment B2. The method of Embodiment B2, wherein the method further comprises receiving the SRS from the WD according to the determined SRS transmission power and/or the PHR.

Embodiment B3. The method of Embodiment B2, wherein:
the SRS configuration indicates information for determining the SRS transmission power for each antenna port of a plurality of antenna ports of the WD, the SRS transmission power being determined to be a smaller value between a first transmission power and a second transmission power, the first transmission power corresponding to a maximum value of transmission power of the at least one antenna port, and the second transmission power corresponding to at least one of:
   a configurable parameter based on a per-port SRS power control capability of the WD; and/or
   additional insertion loss for antenna ports not used for PUSCH or PUCCH transmission of the at least one antenna port; and
the receiving of the SRS further includes receiving the SRS from at least one of the plurality of antenna ports of the WD based on the determined transmission power for the at least one antenna port.

Embodiment C1. A wireless device (WD) configured to communicate with a network node, the WD configured to, and/or comprising a radio interface and/or processing circuitry configured to:
receive, from the network node, a Sounding Reference Signal (SRS) configuration indication including SRS resource set information;
determine a power headroom report (PHR) set for at least one activated serving cell, the PHR including PH information associated with at least one SRS resource included in the SRS resource set; and
transmit, to the network node, the PHR including the PH information for the at least one SRS resource.

Embodiment C2. The WD of Embodiment C1, wherein determining the PHR for the at least one SRS includes determining PH information for each SRS resource included in the SRS resource by determining an SRS transmission power for each SRS resource; and
the WD is further configured to transmit the SRS to the network node with the determined SRS transmission power.

Embodiment C3. The WD of Embodiment C2, wherein:
the determining of the SRS transmission power for each SRS resource further includes determining the SRS transmission power for each antenna port of a plurality of antenna ports of the WD based on the SRS configuration information, the SRS transmission power being determined to be a smaller value between a first transmission power and a second transmission power, the first transmission power corresponding to a maximum value of transmission power of the at least one antenna port, and the second transmission power corresponding to at least one of:
   a configurable parameter based on a per-port SRS power control capability of the WD; and/or
   additional insertion loss for antenna ports not used for PUSCH or PUCCH transmission of the at least one antenna port; and
the transmitting of the SRS further includes transmitting the SRS by at least one of the plurality of antenna ports of the WD based on the determined transmission power for the at least one antenna port.

Embodiment D1. A method implemented in a wireless device (WD), the method comprising:
receiving, from the network node, a Sounding Reference Signal (SRS) configuration indication including SRS resource set information;
determining a power headroom report (PHR) set for at least one activated serving cell, the PHR including PH information associated with at least one SRS resource included in the SRS resource set; and
transmitting, to the network node, the PHR including the PH information for the at least one SRS resource.

Embodiment D2. The method of Embodiment D1, wherein determining the PHR for the at least one SRS includes determining PH information for each SRS resource included in the SRS resource set by determining an SRS transmission power for each SRS resource; and
the method further comprises transmitting the SRS to the network node with the determined SRS transmission power.

Embodiment D3. The method of Embodiment D2, wherein:
the determining of the SRS transmission power for each SRS resource further includes determining the SRS transmission power for each antenna port of a plurality of antenna ports of the WD based on the SRS configuration information, the SRS transmission power being determined to be a smaller value between a first transmission power and a second transmission power, the first transmission power corresponding to a maximum value of transmission power of the at least one antenna port, and the second transmission power corresponding to at least one of:
   a configurable parameter based on a per-port SRS power control capability of the WD; and/or
   additional insertion loss for antenna ports not used for PUSCH or PUCCH transmission of the at least one antenna port; and
the transmitting of the SRS further includes transmitting the SRS by at least one of the plurality of antenna ports of the WD based on the determined transmission power for the at least one antenna port.

1. A network node configured to communicate with a wireless device, WD, the network node comprising a radio interface and processing circuitry to configure the network node to:
determine a Sounding Reference Signal, SRS, configuration indication including SRS resource set information;
transmit the SRS configuration to the WD for determining a power headroom report, PHR, for at least one activated serving cell, the PHR including PH information for at least one SRS resource of a plurality of SRS resources included in the SRS resource set; and
receive responsive to transmitting the SRS configuration, the PHR from the WD including the PH information for the at least one SRS resource.

2. The network node of claim 1, wherein the network node is further configured to receive an SRS from the WD according to the PHR, wherein the PHR includes PH information for at least one SRS resource is determined by an SRS transmission power for the at least one SRS resource.

3. (canceled)

4. A method implemented in a network node, the method comprising:
determining a Sounding Reference Signal, SRS, configuration indication including SRS resource set information;
transmitting the SRS configuration to the WD for determining a power headroom report, PHR, for at least one activated serving cell, the PHR including PH information for at least one SRS resource of a plurality of SRS resources included in the SRS resource set; and
receiving, responsive to transmitting the SRS configuration, the PHR from the WD including the PH information for the at least one SRS resource.

5. The method of claim 4, wherein the method further comprises receiving the SRS from the WD according to the SRS transmission power the PHR, wherein the PHR includes PH information for at least one SRS resource is determined by an SRS transmission power for the at least one SRS resource.

6. (canceled)

7. A wireless device, WD, configured to communicate with a network node, the WD comprising a radio interface and processing circuitry to configured the WD to:
receive from the network node a Sounding Reference Signal, SRS, configuration indication including SRS resource set information;
determine a power headroom report, PHR, for at least one activated serving cell, the PHR including power headroom, PH, information for at least one SRS resource of a plurality of SRS resources included in the SRS resource set; and
transmit to the network node, the PHR including the PH information for the at least one SRS resource.

8. The WD of claim 7, wherein determining the PHR includes determining PH information for at least one SRS resource included in the SRS resource set by determining an SRS transmission power for the at least one SRS resource; and
the WD is further configured to transmit the SRS to the network node (16) with the determined SRS transmission power.

9. The WD of claim 8, wherein the UE is further configured to transmit SRS by switching among antenna ports, wherein at least one SRS resource is transmitted by at least one antenna port and transmitting the at least one SRS resource with the determined transmission power.

10. The WD of claim 7, configured to report a PHR for each SRS resource according to when at least one of the following conditions occurs:
a reporting timer expires;
the SRS configuration is modified;
the UE mapping of SRS ports to physical antenna connectors is modified;
a PDCCH triggers at least one of an SRS transmission and a PHR.

11. The WD of claim 1, configured to report in a medium access control, MAC, control element, MAC-CE, at least one of:
a configured maximum power for each SRS resource in the SRS resource set with dB granularity;
a power-class fallback; and
the PH.

12.-13. (canceled)

14. A method implemented in a wireless device, WD, the method comprising:
receiving from the network node, a Sounding Reference Signal, SRS, configuration indication including SRS resource set information;
determining a power headroom report, PHR, for at least one activated serving cell, the PHR including power headroom, PH, information for at least one SRS resource included in the SRS resource set; and
transmitting to the network node, the PHR including the PH information for the at least one SRS resource.

15. The method of claim 14, wherein determining the PHR for the at least one SRS includes determining PH information for at least SRS resource included in the SRS resource set by determining an SRS transmission power for at least SRS resource; and
the method further comprises transmitting the SRS to the network node with the determined SRS transmission power.

16. The method of claim 15, comprising transmitting SRS by switching among antenna ports, wherein at least one SRS resource is transmitted by at least one antenna port and transmitting the at least one SRS resource with the determined transmission power.

17. The method of claim 14, comprising reporting a PHR for each SRS resource according to when at least one of the following conditions occurs:
a reporting timer expires;
the SRS configuration is modified;
the UE mapping of SRS ports to physical antenna connectors is modified; and
a PDCCH triggers at least one of an SRS transmission and a PHR.

18. The method of claim 14, comprising reporting in a medium access control, MAC, control element, MAC-CE, at least one of
a configured maximum power for each SRS resource in the SRS resource set with dB granularity;
a power-class fallback; and
PH.

19.-20. (canceled)

21. The WD of claim 8, configured to report a PHR for each SRS resource according to when at least one of the following conditions occurs:
a reporting timer expires;
the SRS configuration is modified;
the UE mapping of SRS ports to physical antenna connectors is modified;
a PDCCH triggers at least one of an SRS transmission and a PHR.

22. The WD of claim 8, configured to report in a medium access control, MAC, control element, MAC-CE, at least one of:
a configured maximum power for each SRS resource in the SRS resource set with dB granularity;
a power-class fallback; and
the PH.

23. The WD of claim 9, configured to report a PHR for each SRS resource according to when at least one of the following conditions occurs:
a reporting timer expires;
the SRS configuration is modified;
the UE mapping of SRS ports to physical antenna connectors is modified;
a PDCCH triggers at least one of an SRS transmission and a PHR.

24. The WD of claim 9, configured to report in a medium access control, MAC, control element, MAC-CE, at least one of:
a configured maximum power for each SRS resource in the SRS resource set with dB granularity;
a power-class fallback; and
the PH.

25. The method of claim 15, comprising reporting a PHR for each SRS resource according to when at least one of the following conditions occurs:
a reporting timer expires;
the SRS configuration is modified;
the UE mapping of SRS ports to physical antenna connectors is modified; and
a PDCCH triggers at least one of an SRS transmission and a PHR.

26. The method of claim 15, comprising reporting in a medium access control, MAC, control element, MAC-CE, at least one of
a configured maximum power for each SRS resource in the SRS resource set with dB granularity;
a power-class fallback; and
PH.
